(19) United States
(12) Patent Application Publication
(10) Pub. No.: US 2005/0253388 A1
(43) Pub. Date: Nov. 17, 2005

(54) Hose fitting and method of making

(76) Inventors: Patrick A. Smith, South Euclid, OH (US); Gregory Kreczko, Kalamazoo, MI (US)

Correspondence Address: John A. Molnar, Jr.;PARKER-HANNIFIN CORPORATION, 6035 Parkland Boulevard, Cleveland, OH, 44124-4141, US

(21) Appl. No.: 11/185,060

(22) Filed: Jul. 20, 2005

Related U.S. Application Data
(63) Continuation-in-part of application No. 10/725,916, filed on Dec. 1, 2003.
(60) Provisional application No. 60/438,845, filed on Jan. 8, 2003.

(51) Int. Cl. F28F 9/02; B23P 11/00; F16L 13/14; F16L 19/04

(52) U.S. Cl. 285/382.4; 29/505; 29/507

(57) ABSTRACT

A fitting such as for coupling the end of a length of hose to another member. The fitting includes a generally annular, cylindrical shell for surrounding the hose end, and a tube which is insertable into the hose end. The shell is coaxially mounted onto the tube between a pair of beads which may be upset or otherwise formed into the tube. The shell may be provided as formed at the end thereof which is received over the tube as having an anvil-like portion of an increased wall thickness against which and the first bead the tube may be upset to form the second bead retaining the shell on the tube.

### CROSS-REFERENCE TO RELATED CASES

This application is a continuation-in-part of U.S. patent application Ser. No. 10/725,916, filed Dec. 1, 2003, and claiming priority to U.S. provisional application Ser. No. 60/438,845, filed Jan. 8, 2003, entitled “Process of Forming Two Beads,” the disclosures of each of which are expressly incorporated herein by reference.

### BACKGROUND OF THE INVENTION

The present invention relates generally to barb or nipple-type fittings such as for coupling the end of a length of hose to another member, and more particularly to such a fitting which includes a shell for surrounding the hose end which is mounted between a pair of beads which may be upset or otherwise formed in a tube for insertion into the hose end.

Fittings, such as described, for example, in commonly-assigned U.S. Pat. No. 6,764,106, are used as connectors in order to link fluid conductors with each other. Fittings generally include a tubular element, or tube, having two ends. The first tube end has an outer surface designed to maintain a swivel nut in a predetermined axial location while allowing the swivel nut to rotate. The second tube end has an outer surface which affixedly retains a tubular shell that circumferentially surrounds this end.

The usually externally hexagonally shaped swivel nut typically has internal threads that serve for attachment to the male port end of a fluid conductor. The swivel nut is sealingly fastened onto the noted male port end with a torquing device to a predetermined tightness. During this fastening process the inner end surface of the swivel nut comes into contact with its adjoining tube end such that friction between the two components will cause the entire tube to rotate with the swivel nut.

The second end of the tube has an end portion that is adapted to be inserted into a conduit. The surrounding shell, which is attached to the second end of the tube, surrounds the conduit. The conduit, or course, is the hose or other fluid conductor that is used to transfer fluid from one location to another. Typically, this conduit is flexible so that the fluid can be transferred in multiple directions or angulations without the awkward bending of a rigid pipe. In order to attach the conduit to the fitting, the shell is inwardly deformed so that the intermediate conduit portion is compressed between the shell and the tube.

Rather than providing the tube element with a hexagonally-shaped outer surface, some prior art fittings provide a hexagonally-shaped holding surface on the shell itself. Examples of such a shell are shown in Patent Specification U.S. Pat. No. 4,804,212 to Vyse, which is also assigned to the assignee of the present invention, Patent Specification U.S. Pat. No. 5,317,799 to Chapman et al., and in published PCT Application No. WO 94/18487 to Shiery. These prior art references have hexagonal outer surfaces on the shell which are formed during the inward deformation, or crimping, of the shell onto the conduit. The disadvantage of this type of shell is that the shell can still rotate relative to the conduit and tube while it is being held.

Shells can be fixedly attached to the tube by several methods. As is well known in the art, the inner axial end of the shell can be inwardly deformed, or crimped, onto the tube so that it is compressively attached. Other methods include radially compressing an inwardly directed shoulder of the shell into an annular groove in the tube. This is shown in the previously mentioned Patent Specification U.S. Pat. No. 4,804,212 to Vyse.

Another method of affixing the shell to the tube includes axially compressing an inwardly directed shoulder of the shell between two radially outwardly extending protuberant surfaces, such as annularly formed beads. Examples of such an attachment are shown in Patent Specification U.S. Pat. No. 3,924,883 to Frank; Patent Specification U.S. Pat. No. 6,270,126 B1 to Juedes; and Japanese Pat. No. 5-118483 to Funato.

In view of the foregoing, it is believed that improvements in fittings for hoses and the like allowing for the manufacture thereof at a reduced cost would be well-received in the market.

### SUMMARY OF THE INVENTION

The present invention is directed, broadly, to fittings. More particularly, the invention is directed to a barb or other nipple-type construction, such as for hoses, which eliminates many of the machining and forming process which are otherwise necessary to crimp or otherwise mount the shell onto the nipple.

In an illustrated embodiment, the fitting herein involved is provided in accordance with the precepts of the present invention as including includes a generally annularly cylindrical shell for surrounding the hose end, and a tube which is insertable into the hose end. The shell is coaxially mounted onto the tube between a pair of beads which may be upset or otherwise formed into the tube. Advantageously, the shell may be provided as formed at the end thereof which is received over the tube as having an anvil-like portion of an increased wall thickness against which and the first bead the tube may be upset to form the second bead retaining the shell on the tube.

The present invention, accordingly, comprises the article and method possessing the construction, combination of elements, and arrangement of parts and steps which are exemplified in the detailed disclosure to follow. Advantages of the invention include a fitting construction which is both robust and economical to manufacture. These and other advantages will be readily apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is longitudinal cross-sectional view of fitting construction in accordance with the present invention including a nipple and a shell retained coaxially on the nipple between a first and a second bead formed into the nipple;

FIG. 2 is a longitudinal cross-sectional view of the nipple of the fitting of FIG. 1 as partially formed as having a first bead prior to the shell being received over the nipple; and

FIG. 3 is a longitudinal cross-sectional view showing the shell of FIG. 3 as received over the nipple of FIG. 2 prior to the formation of the second bead.

The drawings will be described further in connection with the following Detailed Description of the Invention.

### DETAILED DESCRIPTION OF THE INVENTION

Certain terminology may be employed in the following description for convenience rather than for any limiting purpose. For example, the terms “forward” and “rearward,” “front” and “rear,” “right” and “left,” “upper” and “lower,” “top” and “bottom,” and “right” and “left” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “vertical” and “axial” or “horizontal” referring, respectively, to directions or planes perpendicular and parallel to the longitudinal central axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

For the illustrative purposes of the discourse to follow, the precepts of the fitting construction of the present invention are described in connection with a “straight” configuration. It is to be appreciated, however, that the present invention will find application in many connector configurations, such as unions, angles, tees, elbows, and crosses, and as port connections for valves, cylinders, manifolds, sensors, and other fluid components. Use within these and other configurations and components therefore should be considered to be expressly within the scope of the invention herein involved.

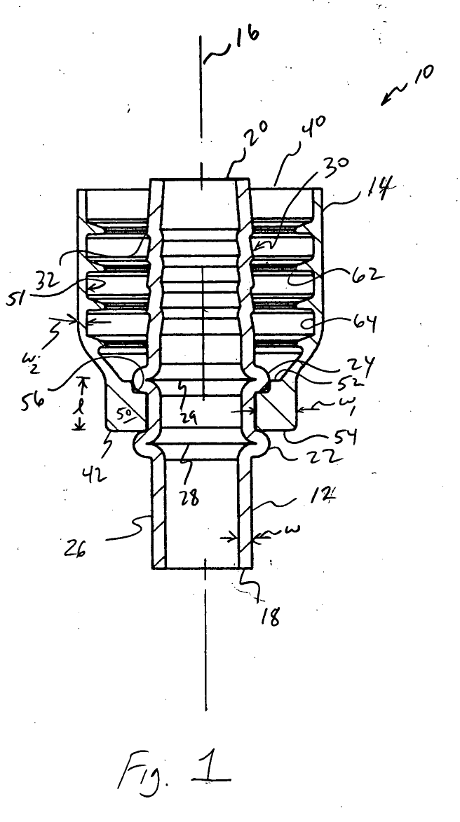

Referring then to the figures wherein corresponding reference characters are used to designate corresponding elements throughout the several views with equivalent elements being referenced with prime or sequential alphanumeric designations, a fitting construction in accordance with the present invention is shown generally at 10 in the cross-sectional view of FIG. 1. As may be seen, fitting 10 includes a generally tubular nipple, 12, and a generally annularly cylindrical shell, 14, which surrounds the nipple 12 as mounted coaxially thereon.

Nipple 12 extends in a axial direction along a longitudinal axis, 16, intermediate a first end, 18, and a second end 20, and is formed intermediated the ends 18 and 20 thereof as having a first bead, 22, and second bead, 24, spaced-apart axially along axis 16 from the first bead 22. Each of the beads 22 and 24 extends circumferentially about the outer surface, 26, of the nipple 12, as well as radially outwardly thereof to form a “bump” of an enlarged diametric extent relative to such extent of the remainder of the nipple. Such “bumps” may be formed by axially collapsing or “upsetting” the nipple 12 such that the wall thickness, referenced at “w,” thereof is doubled or otherwise folded, as at 28 and 29, such as in the manner to be further described hereinafter, or otherwise to define the beads 22 and 24.

The end 20 of nipple 12 surrounded by the shell 14 may be configured as at the portion thereof referenced at 30 as having a series of barbs, one of which is referenced at 32, which may be rolled, machined, or otherwise formed in the outer surface 26 of the nipple 12. Such end portion 30 is sized such as to be insertably receivable, for example, within the end of the hose (not shown) to which the fitting 10 may be attached. The opposite end 20 of the nipple 12 is shown in FIG. 1 to be unformed, but typically will be end-formed to provide a standard end connection, such as a flare or face seal.

As coaxially mounted on nipple, shell 14, which may have the generally bell-shaped configuration shown, similarly extends axially along axis 16 intermediate a distal open end, 40, which surrounds the nipple end portion 30, and more closed proximal end portion, 42, configured as a radially inwardly projecting shoulder which is received over the nipple outer surface 32. With the shell end 42 portion being disposed intermediate the nipple beads 22 and 24, shell 14 thus may be retained on the nipple 12 without the need for crimping or the like. For the purpose to be described herein after, such end portion 42 may be formed has having a section, referenced at 50, of a radial thickness, referenced at w₁, which is thicker than the wall thickness, referenced at w₂, of the portion, referenced at 51, of the shell 14 which surrounds the nipple 12. Such section 50 further may be defined as having an axial length, referenced at “l,” between a generally annular internal end surface, 52, and a generally annular external end surface, 54. Such length l also may be longer than the wall thickness w₂ of the shell 14 is wide. The internal end surface 52 may be further formed as shown as having an undercut or other generally annular half groove or other groove, 56, which may be sized radially to accommodate the seating or other receipt of the second bead 24 therein.

The shell end portion 51 surrounding the nipple end portion 30 may be configured as shown as having a series of ribs or teeth, one of which is referenced at 62, formed in an inner surface, 64, of the nipple 12. Such end portion 51 may be sized to be receivable over, for example, the end of the hose (not shown) to which the fitting 10 may be attached. The inner surface 64 of such shell end portion 51 thus is spaced-apart radially from the outer surface 26 of the nipple end portion 30 so as to accommodate the wall thickness of the hose end (not shown) therebetween. The fitting 10 being so received on the hose end, the shell end portion 30 may be crimped thereon to compressively retain the fitting 10 onto the hose end as gripped between the teeth 62 of the shell 14 and the barbs 32 of the nipple 12.

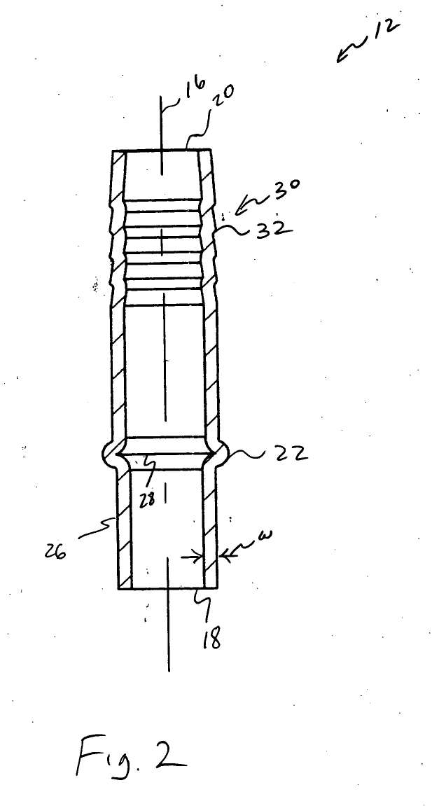

Looking now to the progression of the several views in the sequence of FIG. 2, 3, and 1, an illustrative method of forming the fitting 10 of FIG. 1, which method may be practiced a continuous operation or in separate steps, commences in FIG. 2 with nipple 12 being partially formed as having barbs 32 and the first bead 22. Such first bead 22 may be cold formed in the nipple 12 by means of rolling, punching, swaging, or other conventional end forming operation.

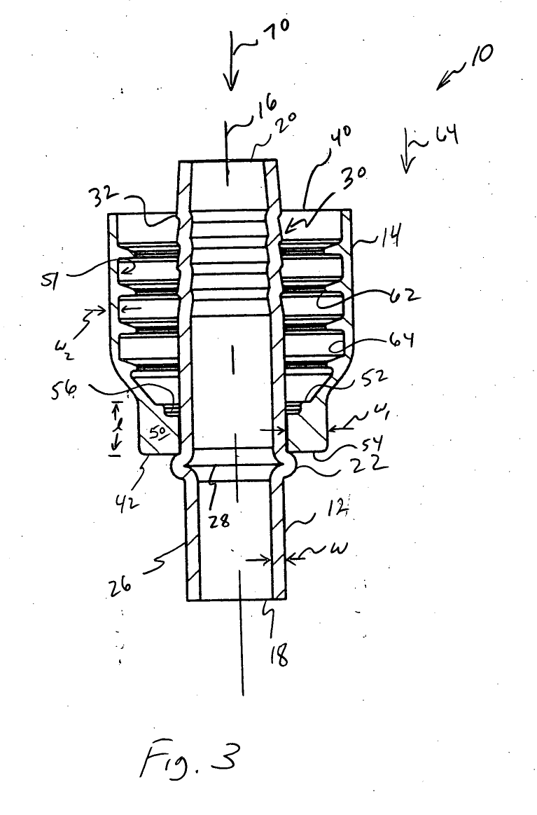

Proceeding to FIG. 3, with the nipple 12 being provided as in FIG. 2, the end portion 42 of shell 14 may be sleeved over the nipple end 20, with the shell 14 then being advanced along axis 16 in the direction indicated by the arrow 64 until the external end surface 54 thereof abuttingly engages the first bead 22. Thereupon, the nipple 12 may be upset, such as by contacting the nipple end 20 with a punch in the direction indicated by the arrow referenced at 70, to form the second bead 24. Returning then to FIG. 1, upon the formation of the second bead 24, the shell 14 is thereby locked in place between the beads 22 and 24, with the second bead 24 being received within the groove 56 formed in the shell internal end surface 52. Advantageously, the increased mass of the section 50 of the shell 14 may be employed to function as an “anvil” against which the nipple 12 may be upset in forming the second bead 24. That is, such section 50 of increased mass can provide the reaction force necessary to counteract the force of the nipple 12 bearing thereon without causing the deformation of the shell 14 and without the need for an additional support which could complicate the forming process.

Although plastics, composites, and other materials may be used where the application permits, the fitting componentry in general may be machined, stamped, cast, molded, or otherwise constructed of a metal, which may be same or different for each of the components, such as copper, brass, steel, stainless steel, titanium, or aluminum, or an alloy such as nickel-copper, Hastelloy®, Alloy 600, 6Mo, Inconel®, or Incoloy®. If necessary or desired, the components may be case hardened by a chemical process such as nitriding, carburizing, or Kolsterizing, or by heat treatment or other treatment method such as precipitation hardening, work hardening, or a surface coating or plating. Additionally, the work surfaces may be coated, such as by a chemical solution plating or another means such as a physical or chemical vapor deposition, with molybdenum disulfide, silver or other lubricious material to reduce the required assembly torque and/or any potential for galling.

Thus, a unique fitting construction is described herein which is both robust and economical to manufacture using forming processes. Such construction, moreover, is adaptable to a variety of standard end configurations and types.

As it is anticipated that certain changes may be made in the present invention without departing from the precepts herein involved, it is intended that all matter contained in the foregoing description shall be interpreted in as illustrative rather than in a limiting sense. All references including any priority documents cited herein are expressly incorporated by reference.

1. A fitting comprising:
a generally tubular nipple extending along a longitudinal axis intermediate a first end and a second end, the nipple having a wall thickness and a first bead formed as a first fold in the wall thickness intermediate the first and the second nipple end, and a second bead formed as a second fold in the wall thickness intermediate the first bead and the nipple second end, and
a generally annular shell received coaxially over the nipple, the shell extending along the longitudinal axis intermediate an open end portion surrounding the nipple and a shoulder end portion retained intermediated the nipple first and second beads, the shell open end 10 portion having a first wall thickness, and the shell shoulder end portion having a section of a second wall thickness, the section having an axial length extending along the longitudinal axis intermediate a generally annular internal surface and a generally annular external surface, one or both of the second wall thickness and the axial length of the shell shoulder portion section having an extent great than that of the shell open end portion first wall thickness.

2. The fitting of claim 1 wherein the internal surface of the shell shoulder end portion section is formed as having a groove, the second bead of the nipple being received within the groove.

3. A method of making a fitting comprising the steps of:
(a) providing a generally tubular nipple extending along a longitudinal axis intermediate a first end and a second end, the nipple having a wall thickness and a first bead formed as a first fold in the wall thickness intermediate the first and the second nipple end;
(b) disposing a generally annular shell coaxially over the nipple, the shell extending along the longitudinal axis intermediate an open end portion surrounding the nipple and a shoulder end portion disposed intermediated the nipple first bead and second end, the shell open end portion having a first wall thickness, and the shell shoulder end portion having a section of a second wall thickness, the section having an axial length extending along the longitudinal axis intermediate a generally annular internal surface and a generally annular external surface, one or both of the second wall thickness and the axial length of the shell shoulder portion section having an extent great than that of the shell open end portion first wall thickness; and
(c) upsetting the nipple against the shell shoulder end portion section to form a second bead as a second fold in the wall thickness intermediate the shell shoulder end portion and the nipple second end, the shell being retained on the nipple between the first and second beads.

4. The method of claim 3 wherein the internal surface of the shell shoulder end portion section is formed as having a groove, the second bead of the nipple being received in sep (c) within the groove.
